(19) United States
(12) Patent Application Publication
(10) Pub. No.: US 2014/0170199 A1
(43) Pub. Date: Jun. 19, 2014

(54) PARASITICIDAL COMBINATION COMPRISING INDOXACARB AND DELTAMETHRIN

(71) Applicant: E.I. du Pont de Nemours and Company, Wilmington, DE (US)

(72) Inventors: Annie Flochlay-Sigognault, Angers (FR); Frank Guerino, Monroe Township, NJ (US); Bruno Lapied, Angers (FR)

(21) Appl. No.: 14/124,010

(22) PCT Filed: Jun. 8, 2012
(86) PCT No.: PCT/US12/41580

§ 371 Date: Feb. 19, 2014

Related U.S. Application Data
(60) Provisional application No. 61/494,608, filed on Jun. 8, 2011.

(51) Int. Cl. A01N 53/00; A01N 43/88

(52) U.S. Cl. CPC A01N 53/00; A01N 43/88
USPC 424/411; 514/229.2

(57) ABSTRACT

The invention relates to antiparasitic compositions comprising a combination of indoxacarb and deltamethrin and their use in a method to control parasite insect- and acarid-infestations on animals.

The present invention relates to veterinary compositions for the control of parasitic insects and acarids

Deltamethrin ((S)-α-Cyano-3-phenoxybenzyl-(1R,3R)-3-(2,2-dibromovinyl)-2,2-dimethylcyclopropanecarboxylate) CAS-No. 52918-63-5 is a known agricultural and veterinary insecticide and acaricide and is e.g. commercially available in the veterinary products Butox®, and Scalibor® (Merck Animal Health).

Indoxacarb is a known agricultural insecticide. U.S. Pat. No. 5,462,938 discloses novel arthropodicidal compositions and methods relating to oxadiazinyl carboxanilides compounds having efficacy against household, foliar and soil-inhabiting agronomic and non-agronomic pests. A compound disclosed therein, (5)-methyl 7-chloro-2,5-dihydro-2-[[methoxycarbonyl) [4 (trifluoromethoxy) phenyl]amino]carbonyl]indeno[1,2-e][1,3,4]oxadiazine-4a(3H)-carboxylate; common name: Indoxacarb, or DPX-KN128 has been registered by the EPA as a “reduced-risk” pesticide, Indoxacarb may be identified by its U.S. EPA PC Code 067710, or CAS No. 173584-44-6, Indoxacarb by itself has excellent activity against parasitic insects such as fleas but, more limited activity against parasitic acarids such as ticks. Indoxacarb is commercially available as a veterinary product for topical application as Activyl®. (Merck Animal Health)

Surprisingly, the combination of indoxacarb and deltamethrin has been found to produce enhanced acaricidal activity as well as maintain continued excellent activity against parasitic insects such as fleas.

### SUMMARY OF THE INVENTION

In accordance with the foregoing, the present invention encompasses the use of a combination of indoxacarb and deltamethrin for the preparation of a product for the control of parasitic acarids on animals.

Hence the current invention provides a parasiticidal combination comprising as active compounds indoxacarb and deltamethrin in synergistically effective amounts.

Furthermore the current invention is directed to the use of such combination for combating parasitic insects and acarids on homoethermic animals especially for the control of parasitic acarids on animals, especially when applied topically, especially to a dog.

In one embodiment indoxacarb and deltamethrin are contained in two separate formulations for application in parallel.

In one embodiment, indoxacarb and deltamethrin are contained in two separate formulations wherein the formulation containing deltamethrin is in the form of a collar impregnated with deltamethrin.

In another embodiment indoxacarb and deltamethrin are contained in a common (single) formulation.

In one embodiment deltamethrin and indoxacarb are contained in a common (single) formulation in the form of a collar impregnated with both actives.

In one embodiment the ratio by weight of indoxacarb to deltamethrin is between 1 to 10 and 10 to 1.

In other embodiments the ratio by weight between indoxacarb and deltamethrin can be between about 1 to 1000 and about 1000 to 1, between about 1 to 500 and about 500 to 1, between about 1 to 300 and about 300 to 1, between about 1 to 100 and about 100 to 1, between about 1 to 50 and 50 to 1 or about 1 to 25 and 25 to 1, between about 1 to 10 and 10 to 1, between about 1 to 5 and 5 to 1, between about 1 to 3 and about 3 to 1, about 1 to 2.5 and 2.5 to 1 or about 1 to 1.

In one embodiment the invention is directed to a parasiticidal composition comprising the combination described above and a pharmaceutically acceptable carrier

In another embodiment the invention is directed to a kit useful in the treatment of a parasite infestation of insects and/or acarids in an animal, which comprises indoxacarb and deltamethrin in a single composition or separate compositions and instructions for the control of parasitic insect- and acarid-infestations on animals.

Furthermore the current invention is directed to a method for protecting animals against infestations by parasites which comprises administering to the animal an effective amount of the combination as described above to the animal in need thereof.

Furthermore the current invention is directed to a method for treating animals infested by parasites which comprises administering to the animal an effective amount of a combination as described above to the animal in need thereof, especially wherein indoxacarb and deltamethrin are administered together simultaneously in a common formulation, or in separate formulations simultaneously or in succession.

The invention is described more fully hereunder.

### DETAILED DESCRIPTION OF THE INVENTION

### Animal Health Applications

The invention encompasses a parasiticidal combination of indoxacarb and deltamethrin. It has been found that the combination of these active ingredients produces a synergistic effect of significantly enhancing onset of activity (control) against acarids such as ticks and mites, and long-term activity (control) against ticks and fleas. This is unexpected because indoxacarb alone generally has limited activity against acarids such as ticks and mites, and deltamethrin alone, generally, has limited and short duration of activity against parasitic insects such as fleas. Surprisingly, indoxacarb in combination with deltamethrin has been found to significantly enhance the kill activity against these parasites, and thus provides excellent control. Moreover, in the use of the combination against parasitic insects, such as fleas, indoxacarb activity has not been negatively affected by deltamethrin.

As set forth above, the invention relates to a combination of indoxacarb and deltamethrin and the use of compositions comprising a combination of indoxacarb and deltamethrin in effective concentrations to provide enhanced acaricidal activity without producing a detrimental effect on the activity of indoxacarbon parasitic insects such as fleas. Both Indoxacarb and deltamethrin are sodium channel blocker and/or modulator insecticides, but the manner they alter insect sodium channels differs.

The systematic chemical name for Indoxacarb is (5)-methyl 7-chloro-2,5-dihydro-2-[[(methoxycarbonyl) [4-(trifluoromethoxy)phenyl]amino]carbonyl]indeno[1,2-e][1,3,4]oxadiazine-4a(3H)-carboxylate. Indoxacarb kills by binding to a site on the sodium channels and blocking the flow of sodium ions into nerve cells resulting in impaired nerve function, feeding cessation, paralysis, and death. Indoxacarb, is a pro-insecticide, that must be metabolized first in order to become toxic. The pesticidally active enantiomer DPX-KN128 is rapidly degraded by enzymes in and near the insect gut, mainly after ingestion to the much more insecticidally active metabolite IN-JT333, also referred to as DCJW or (methyl 7-chloro-2,5-dihydro-2-[[[4-(trifluoromethoxy)phenyl]amino]carbonyl]indeno-[1,2-e][1,3,4]oxadiazine-4a(3H)-carboxylate) in the literature. An esterase or amidase is required to complete the conversion. IN-JT333 is more effective than indoxacarb at blocking sodium channels resulting in a higher toxicity than the parent compound.

Type II pyrethroids, including deltamethrin, have an α-cyano group that slow the gating effects of the sodium channel activation gate. This results in prolonged permeability of the nerve to sodium and produces a series of repetitive nerve signals in sensory organs, sensory nerves, and muscles.

Surprisingly, the combination of indoxacarb and deltamethrin provides enhanced acaricidal activity while maintaining the activity of indoxacarb against parasitic insects e.g. fleas. The enhanced activity is most notable when the two compounds are first applied producing a faster kill of acarids than deltamethrin alone and then again at the end of the effective treatment duration when the effects of deltamethrin alone begins to decline.

The compositions of the invention are particularly suitable for control of parasitic acarids and parasitic insects, particularly ticks, mites and lice, flies and fleas on animals, as well, as premise control of lice, flies and fleas, ticks and mites and other susceptible insects.

The term “animal” is intended to include all homeothermic animals including humans.

The term “control” or “controlling” herein means rendering the insects and acarids innocuous, preferably by killing the insect and acarids to the extent that at least 80% die within a few days; and preferably within 2 days of application. In the preferred embodiment, the treated target is infested with insects and/or acarids. In the practice of the invention, the composition can be applied in any convenient manner.

The term “combating” as used herein means controlling insects and acarids already present on an animal or its immediate surroundings as well as preventing substantial infestation of the animal with such parasites. A “substantial” infestation is one in which the host animal exhibits symptoms of infestation.

In case indoxacarb and deltamethrin are administered individually in separate dosage forms they are administered in parallel. “Parallel” means that the active ingredients may be administered at the same time, that is simultaneously.

Indoxacarb and deltamethrin may also be administered sequentially, that is one after the other i.e. so that they are present together for certain periods at the latest in the host organism, so that the desired effect arises.

By the term combination is meant a regimen of applying the two active ingredients, either together or separately but parallel.

In one embodiment the active ingredients are administered simultaneously. In one embodiment the combination of indoxacarb and deltamethrin is presented as a single dosage form comprising both compounds in a single formulation.

In order to form the composition according to the invention the active ingredients may be present in the dosage form as true mixtures, but they may also be administered individually in separate dosage forms and form mixtures only when they are on or in the host organism.

Administration of the active compounds is carried out directly or in the form of suitable preparations.

In a preferred embodiment of the present invention, the compositions comprising the combinations of the present invention are applied dermally/topically.

Typical compositions for this purpose include pour-on, spot-on, dip, spray, mousse, shampoo, powder formulation, gels, hydrogels, lotions, solutions, creams, ointments, dusting powders, dressings, foams, films, skin patches, collars, ear tags, medallions, bandages and the like. Ear acarids may be controlled by composition applied directly into the ears. Useful topical compositions comprising indoxacarb are disclosed in U.S. Patent Publication 20100099668. A topical formulation sold by Merck Animal Health (ACTIVYL®) may be purchased.

In a further preferred embodiment, the topical application is conducted in the form of compound-containing shaped articles such as collars, medallions, ear tags, bands for fixing at body parts, and adhesive strips and foils.

One such embodiment makes use of polymeric collars, ear tags and other solid compositions which provide for the controlled release of deltamethrin and indoxacarb either in separate compositions or together in the same composition. While other polymers can be used, preferred compositions often include polyvinyl chloride (PVC) or other vinyl polymers combined with relatively high levels of solvating plasticizer. The amount of plasticizer used is often the maximum amount possible while still maintaining a dry and flowable blend. Separately the active ingredients are blended with a solid active ingredient carrier such as triphenylphosphate (TPP) as described in U.S. Pat. No. 5,437,869.

Of note are polymers and copolymers of vinyl monomers such as vinyl chloride, vinyl acetate, acrylates and the like. Such polymers are described in U.S. Pat. Nos. 3,318,769 and 3,852,416, are suitable for use in the present invention. The solvating plasticizer used in such polymeric pest control systems of the present invention are often liquid plasticizers conventionally employed in polymeric pest control systems. These include the phthalic esters such as dioctyl phthlate, adipic esters such as dioctyl adipate, and the like. The optimal ratio of deltamethrin and/or indoxacarb to triphenylphosphate is easily determined by routine experimentation by measuring release rates of active.

Of note are compositions in which deltamethrin and/or indoxacarb and triphenylphosphate are incorporated in the composition at least 1:1 or in which triphenylphosphate is incorporated at a molar concentration at least double or several fold over the concentration of deltamethrin and in which the polymer matrix is a vinyl polymer or copolymer.

An example of such a collar containing 4% deltamethrin alone is sold under the trademark SCALIBOR®, by Merck Animal Health.

An exemplary formulation is illustrated below:

| Ingredient | % by weight |
|---|---|
| PVC (polyvinyl chloride) | 40.5 |
| Stabilizer (Witco CZ19A) | 0.50 |
| Epoxidized Soybean Oil | 5.00 |
| Diisooctyl adipate | 18.00 |
| TPP | 28.0 |
| Deltamethrin Tech 98% | 4.0 |
| lndoxacarb (DPX-KN128) | 4.0 |

In one embodiment of the invention, synergistic results are obtained when the active ingredients are applied concurrently as separate formulations or together.

The compositions according to the current invention further comprise a pharmaceutically or veterinarily acceptable carrier. Examples of ingredients or compounds that may be comprised within the veterinarily acceptable carrier include solvents, crystallization inhibitors, antioxidants, adjuvants, cosolvents, colorants, surfactants, oils, light stabilizers, tackifiers, suspending agents, propellants, bulking agents and fragrance enhancers or maskers. Such carrier can be liquid, solid or semi-solid. The compositions conventionally further comprise physiologically acceptable formulation excipients known in the art e.g. as described in “Gennaro, Remington: The Science and Practice of Pharmacy” (20th Edition, 2000) incorporated by reference herein. All such components, carriers and excipients must be substantially pharmaceutically or veterinary pure and non-toxic in the amounts employed and must be compatible with the active ingredients.

The term “parasitic insect- and acarid” refers to ectoparasites e.g. insect and acarine pests that commonly infest or infect animals. Examples of such ectoparasites include the egg, larval, pupal, nymphal and adult stages of lice, fleas, mosquitoes, mites, ticks biting or nuisance fly species. Especially important are the adult stages of Diptera (including the family Culicidae), fleas and ticks.

The combination is particularly effective against parasitic insects, especially Siphoneptera (fleas), and Acarina (ticks and mites). Biting pests including sand flies and mosquitoes are contemplated. Surprisingly, the combination has been found to be particularly effective against ticks on dogs, especially on Rhipicephalus sanguineus. The results are unexpected because the indoxacarb has no appreciable activity against acarids such as ticks and mites; yet the combination thereof with deltamethrin results in a substantially enhanced activity against these parasites. Additionally, the exceptional activity of indoxacarb against parasitic insects such as fleas is not reduced.

The composition according to the invention may additionally comprise other active ingredients such as repellants and insect growth regulators (e.g. pyriproxifen, methoprene), which do not interfere with the preparation or efficacy of the combination.

In another embodiment the invention relates to the use of a combination of indoxacarb and deltamethrin for the manufacture of a veterinary medicament for the control of parasitic insect- and acarid-infestations on animals. In one embodiment the combination includes a synergistic amount of indoxacarb and deltamethrin.

Protection of animals from the infestation of parasitic insects or acarides, may be provided by the application or administration of a prophylactically or therapeutically effective amount of the combination as defined above.

The combination of the present invention are especially useful for combating parasitic insects and acarides of the following orders and species, respectively: fleas (Siphonaptera), e.g. Ctenocephalides felis, Ctenocephalides canis, Xenopsylla cheopis, Pulex irritans, Tunga penetrans, and Nosopsyllus fasciatus, flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culiseta inor-nata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Lep-toconops torrens, Lucilia caprina, Lucilia cuprina, Lucilia sericata, Lycoria pectoralis, Mansonia spp., Musca domestica, Muscina stabulans, Oestrus ovis, Phlebotomus ar-gentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola, and Tabanus similis, lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus; ticks and parasitic mites (Parasitiformes): ticks (Ixodida), e.g. Ixodes ricinus, Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and parasitic mites (Mesostigmata), e.g. Orni-thonyssus bacoti and Dermanyssus gallinae, Actinedida (Prostigmata) and Acaridida (Astigmata) e.g. Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., and Laminosioptes spp, Bugs (Heteropterida): Cimex lectularius, Cimex hemipterus, Reduvius senilis, Triatoma spp., Rhodnius ssp., Panstrongylus ssp. and Arilus critatus, Anoplurida, e.g. Haematopinus spp., Linognathus spp., Pediculus spp., Phtirus spp., and Solenopotes spp, Mallophagida (suborders Arnblycerina and Ischnocerina), e.g. Trimenopon spp., Menopon spp., Trinoton spp., Bovicola spp., Werneckiella spp., Lepikentron spp., Trichodectes spp., and Felicola spp,

The administration can be continuing or seasonal and can be carried out both prophylactically and therapeutically.

The invention also relates to compositions containing a parasiticidally effective amount of indoxacarb and deltamethrin and an acceptable carrier, for combating parasites on animals.

The present invention also provides a method for treating, controlling, preventing and protecting animals against infestation and infection by parasites, which comprises administering or applying to the animals a parasiticidally effective amount of combination of the present invention or a composition comprising it.

The invention also provides a process for the preparation of a composition for treating, controlling, preventing or protecting animals against infestation or infection by parasites which comprises a parasiticidally effective amount of a combination of the present invention or a composition comprising it.

The invention also relates to such a use with a therapeutic aim intended for the treatment and prevention of parasitoses having pathogenic consequences for the host animal.

The ratio by weight between indoxacarb and deltamethrin can be between about 1 to 1000 and about 1000 to 1, between about 1 to 500 and about 500 to 1, between about 1 to 300 and about 300 to 1, between about 1 to 100 and about 100 to 1, between about 1 to 50 and 50 to 1 or about 1 to 25 and 25 to 1, between about 1 to 10 and 10 to 1, between about 1 to 5 and 5 to 1, between about 1 to 3 and about 3 to 1, about 1 to 2.5 and 2.5 to 1 or about 1 to 1.

Another aspect of the invention is a kit useful in the treatment of a parasite infestation of insects and/or acarids in an animal, which comprises indoxacarb and deltamethrin in a single composition or separate compositions and instructions for the control of parasitic insect- and acarid-infestations on animals.

In general the composition according to the current invention can be administered to all species of animals that have insect- or acarid-pest infestation. The recipient of the formulation may be a livestock animal, e.g. sheep, cattle, pig, goat or poultry; a laboratory test animal, e.g. guinea pig, rat or mouse; or a companion animal, e.g. dog, cat, rabbit, ferret or horse. The compositions according to the invention are especially suitable for use in companion animals, e.g. dogs, cats or ferrets.

### Cockroach Control

As illustrated in the Examples indoxacarb and deltamethrin exhibit a synergistic effect when applied to cockroach neuronal cells.

A preferred embodiment of the present invention is a method for controlling cockroaches by applying a pesticidally effective amount of a composition comprised of indoxacarb and deltamethrin to a locus where cockroach control is needed or expected to be needed, for example, a pest-infested structure, a structure that is expected to be pest-infested, or a location adjacent to these structures.

Another embodiment of the present invention is a method for the control of cockroaches which comprises applying a synergistically effective amount of indoxacarb and a synergistically effective amount of deltamethrin either together or sequentially; in any order, to a locus where cockroach control is needed or expected to be needed wherein the applied weight ratio of indoxacarb and deltamethrin can be between about 1 to 1000 and about 1000 to 1, between about 1 to 500 and about 500 to 1, between about 1 to 300 and about 300 to 1, between about 1 to 100 and about 100 to 1, between about 1 to 50 and 50 to 1 or about 1 to 25 and 25 to 1, between about 1 to 10 and 10 to 1, between about 1 to 5 and 5 to 1, between about 1 to 3 and about 3 to 1, about 1 to 2.5 and 2.5 to 1 or about 1 to 1.

The method of the present invention is particularly useful in the control of cockroaches such as, but not limited to, American cockroach and German cockroach.

The synergistically effective amount of the combination of indoxacarb and deltamethrin can vary according to the weather conditions, soil conditions, mode of application, application timing and the like.

This method of the present invention may employ the pesticidal active ingredients (ai's) in many forms and are often most conveniently prepared in liquid form immediately prior to use. One method of preparing such a composition is referred tows “tank mixing” in which the active ingredients in their commercially available form, either with or without other additives, are mixed together by the user in a quantity of water.

In addition to tank mixing immediately prior to use the compositions of the present invention may be formulated into a more concentrated primary composition which is diluted with water or other diluent before use. Examples of such formulations of pesticides that are or can be dispensed in an aqueous medium prior to application are also within the scope of the present invention, for example, granules of relatively large particle size (for example, 8/16 or 4/8 US Mesh), micro-emulsions, suspension concentrates, emulsifiable concentrates, wettable powders, water-soluble or water-dispersible granules, powdery dusts, capsule suspensions, emulsifiable granules, aqueous emulsions, solutions or combinations thereof, depending on the desired mode of application to the areas in which control of cockroaches and/or spiders is desired. These formulations may contain as little as 0.1%, 0.2% or 0.5% to as much as 95% or more by weight of the total of the two pesticides. Such compositions may comprise a surface active, agent in addition to the active ingredients and examples of such compositions are set forth below.

The pesticidal composition can be in the form of a dispersible solution which comprises the pesticides dissolved in a water-miscible solvent with the addition of a dispersing agent. Alternatively it can comprise the pesticides in the form of a finely ground powder in association with a dispersing agent and intimately mixed with water to give a paste or cream which can if desired be added to an emulsion of oil in water to give a dispersion of the two pesticides in an aqueous oil emulsion.

Alternatively, the pesticidal composition can be the form of water-soluble or water-dispersible granules that, disperse readily in water or other dispersant. Water-soluble or water-dispersible granules normally are prepared to contain about 5-80% of the pesticides, depending on the absorbency of the carrier, and usually also contain a wetting, dispersing or emulsifying agent to facilitate dispersion and may contain a preservative. Typical carriers for water-soluble or water-dispersible granules include Fullers earth, natural clays, silicas, and other highly absorbent, readily wet inorganic diluents. For example, a useful water-soluble or water-dispersible granule formulation contains 26.71 parts of the pesticides, 30.90 parts of ammonium sulfate, 30.89 parts of continental clay, 10.00 parts of sodium lignosulfonate as a dispersant, 1.00 part of sodium dioctylsuccinate as a wetting agent and 0.50 part of citric acid as a preservative. The mixture is milled, diluted with water to form a paste and the paste is extruded and dried to produce granules.

Other alternatives that may be employed are dusts which are free flowing admixtures of the pesticides with finely divided solids such as talc, natural clays, kieselguhr, flours such as walnut shell and cottonseed flours; and other organic and inorganic solids which act as dispersants and carriers for the pesticides. These finely divided solids have an average particle size of less than about 50 microns. A typical dust formulation useful herein is one containing 1.0 part or less of the pesticidal compounds and 99.0 parts of talc.

Also useful formulations for the pesticidal compositions of the present invention are wettable powders in the form of finely divided particles that disperse readily in water or other dispersant. The wettable powder is ultimately applied to the locus where pest control is needed either as a dry dust or as an emulsion in water or other liquid. Typical carriers for wettable powders include Fullers earth, kaolin clays, silicas, and other highly absorbent, readily wet inorganic diluents. Wettable powders are prepared to contain about 5-80% of the pesticides, depending on the absorbency of the carrier, and usually also contain a small amount of a wetting, dispersing or emulsifying agent to facilitate dispersion. For example, a useful wettable powder formulation contains 80.0 parts of the pesticidal compounds, 17.9 parts of Palmetto clay, and 1.0 part of sodium lignosulfonate and 0.3 part of sulfonated aliphatic polyester as wetting agents. Additional wetting agents and/or oils will frequently be added to a tank mix to facilitate dispersion on the target site.

Other useful formulations for the pesticidal compositions employed in the practice of the present invention are emulsifiable concentrates (ECs) which are homogeneous liquid compositions dispersible in water or other dispersant, and may consist entirely of the pesticidal compounds and a liquid or solid emulsifying agent, or may also contain a liquid carrier, such as xylene, heavy aromatic naphthas, isophorone, or other non-volatile organic solvents. For pesticidal application these concentrates are dispersed in water or other liquid carriers and applied as a spray to the area to be treated. The percentage by weight of the pesticidal compounds may vary according to the manner in which the composition is to be applied, but in general comprises 0.5 to 95% of the pesticidal compounds by weight of the total composition.

Suspension concentrate formulations may also be employed. These are similar to ECs, except that the pesticidal compounds are suspended in a liquid carrier, generally water. Suspension concentrates, like ECs, may include a small amount of a surfactant, and will typically contain the pesticidal compounds in the range of 0.5 to 95%, frequently from 10 to 50%, by weight of the total composition. For example, a useful suspension concentrate formulation contains 22.0 parts of the pesticidal compounds, 2.6 parts of an ethoxylated/propoxylated block copolymer surfactant, 0.4 part phosphate ester surfactant, 0.8 part thickening agent, 6.0 parts antifreeze agent, 0.1 antifoam agent, 0.05 part anti-bactericide and 44.0 parts distilled water. For pesticidal application, suspension concentrates may be diluted in water or other liquid vehicle, and are normally applied as a spray to the area to be treated.

Other useful formulations include suspensions of the pesticidal compounds in a relatively non-volatile solvent such as water, corn oil, kerosene, propylene glycol, or other suitable solvents.

Still other useful formulations for these pesticidal compositions include simple solutions of the pesticides in a solvent in which it is completely soluble at the desired concentration, such as acetone, alkylated naphthalenes, xylene, or other organic solvents. Pressurized sprays, typically aerosols wherein the pesticides are dispersed in finely divided form as a result of vaporization of a low-boiling dispersant solvent carrier may also be used.

Another useful formulation for the pesticidal compositions of the present invention is sustained release formulations as described in U.S. Pat. No. 5,437,869 or in baits.

In some circumstances it may be desirable to combine two types of formulation e.g. one of the pesticidal compounds is used as an emulsifiable concentrate and the second pesticidal compound is dispersed as a powder in this concentrate.

The concentration of the active pesticides (when used as the sole active components) in a composition for direct application to the desired site by conventional methods is preferably within the range of 0.001 to 10% by weight of the composition, especially 0.005 to 5% by weight but more concentrated compositions containing up to 40% may be desirable.

Typical wetting, dispersing or emulsifying agents that may be used in the compositions of the present invention include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 15% by weight of the composition.

The invention is further illustrated but is not intended to be limited by the following examples in which all parts and percentages are by weight unless otherwise specified.

### Example 1

The purpose of this study was to determine comparative flea and tick control over a six month interval of a combination application of indoxacarb and deltamethrin applied dermally to dogs. This combination was compared with indoxacarb alone and deltamethrin alone.

The SCALIBOR® collar was administered to dogs according to the instructions in the Product leaflet. The topical formulation of indoxacarb was administered to dogs in Groups 3 and 4 according to the dose table below:

TABLE 1

| IVP | Group | Weight range | Dose |
|---|---|---|---|
| indoxacarb | 3 and 4 | ≦6.36 kg | 0.50 ml |
| | | >6.36 kg to ≦10 kg | 0.77 ml |
| | | >10 kg to ≦20 kg | 1.54 ml |
| | | >20 kg to ≦40 kg | 3.08 ml |

A 4% deltamethrin-impregnated collar (SCALIBOR®, Merck Animal Health) is used to protect dogs from the bites of sand flies (Phlebotomus sp.), mosquitoes (Culex sp.), and ticks for up to six months with high persistent efficacy. Immediate efficacy of the collar against fleas is known to be inadequate. This study was designed to evaluate the efficacy and safety of concurrent use of an indoxacarb spot-on as described in U.S. Patent Publication 20100099668 as formulation “AC” (marketed as ACTIVYL™, by Merck Animal Health) and a 4% deltamethrin-impregnated collar for the long term control of Ctenocephalides felis fleas and Rhipicephalus sanguineus ticks on dogs.

The study was conducted on four groups of eight dogs each.
Group 1: Negative control.
Group 2: Dogs were fitted with the Scalibor® collar on Day 0.
Group 3: Dogs were treated with a topical formulation of indoxacarb on Days 0, 30, 60, 90, 120, 150, and 180 (once a month for 6 months).
Group 4: Dogs were fitted with the Scalibor® collar (4% deltamethrin) on Day 0 and treated with a topical formulation of indoxacarb on Days 0, 30, 60, 90, 120, 150, and 180 (once a month for 6 months).
   Dogs were experimentally infested with 100 fleas and 50 ticks two days before treatment (Day 0) and then on various days throughout the study.

TABLE 2
STUDY PROCEDURES:

| | | | | | Blood |
|---|---|---|---|---|---|
| Tick | Flea | Assessments: | Assessments: | Local | collection |
| infestations | infestations | Tick counts¹ | Flea counts¹ | tolerance | (fasted) |
| Day: −2, | Day: −7, −2, | Day: +2, +16, | Day: −5, +2, | Day: −1, | Day: −1 |
| +14, +28, | +7, +28, | +30, +44, +72, | +9, +30, +37, | +2, +9, | and +180 |
| +42, +70, | +35, +63, | +100, +128, | +65, +93, | +16, +23, | |
| +98, +126, | +91, +119, | +156, +170 | +121, +149, | +30, +37, | |
| +154, +168 | +147, +161 | and +184 | +163 and | +44, +65, | |
| and +182 | and +175 | | +177 | +72, +93, | |
| | | | | +100, +121, | |
| | | | | +128, +149, | |
| | | | | +156, +163, | |
| | | | | +170, +177 | |
| | | | | and +184 | |

¹Tick and flea counts was conducted approximately 48 hours after treatment or artificial infestation

### Methods for Calculating the Product Effect

Efficacy against ticks and fleas was calculated for each treatment group at each assessment day according to the formulas given below. Due to the fact that small and even zero tick and flea counts were recorded, it was expected that the tick and flea counts would not follow a normal distribution. It was therefore decided that the primary efficacy calculations would be based on geometric means rather than arithmetic means. The calculations were based on the geometric means of the tick or flea (count+1) data. One (1) was subsequently subtracted from the result to obtain a meaningful value for the geometric mean of each treatment group. Efficacy calculations based on arithmetic means were, however, also reported on.

Percent efficacy against ticks was calculated as follows:

Efficacy(%)=100×(Gm_{c}−Gmₜ)/Gm_{c}, where:

Gm_{c}=Geometric or arithmetic mean number of live ticks (categories 1-3) on dogs in the control group (Group 1) at a specific time point.
Gmₜ=Geometric or arithmetic mean number of live ticks (categories 1-3; immediate Day+2 efficacy) and dead attached engorged ticks (category 6; residual >Day+2 efficacies) on dogs in the treatment groups (Groups 2, 3 & 4) at a specific time point.

Percent efficacy against fleas was calculated as follows:

Efficacy(%)=100×(m_{c}−mₜ)/m_{c}, where

m_{c}=geometric mean of live fleas on the control group (Group 1)
mₜ=geometric mean of live fleas on the treated group (Groups 2, 3 & 4)

Descriptive statistics (mean, minimum, maximum, standard deviation, CV %, geometric mean and median) on tick and flea counts for the various assessment days were calculated and tabulated.

### Results:

### Tick Counts

Arithmetic and geometric mean tick counts on the various assessment days for the five study groups are summarized in Table 3. The arithmetic mean tick counts recorded for the negative control group ranged from 20.9 to 30.6 indicating vigorous tick challenges on all assessment days.

Efficacy Data R. sanguineus

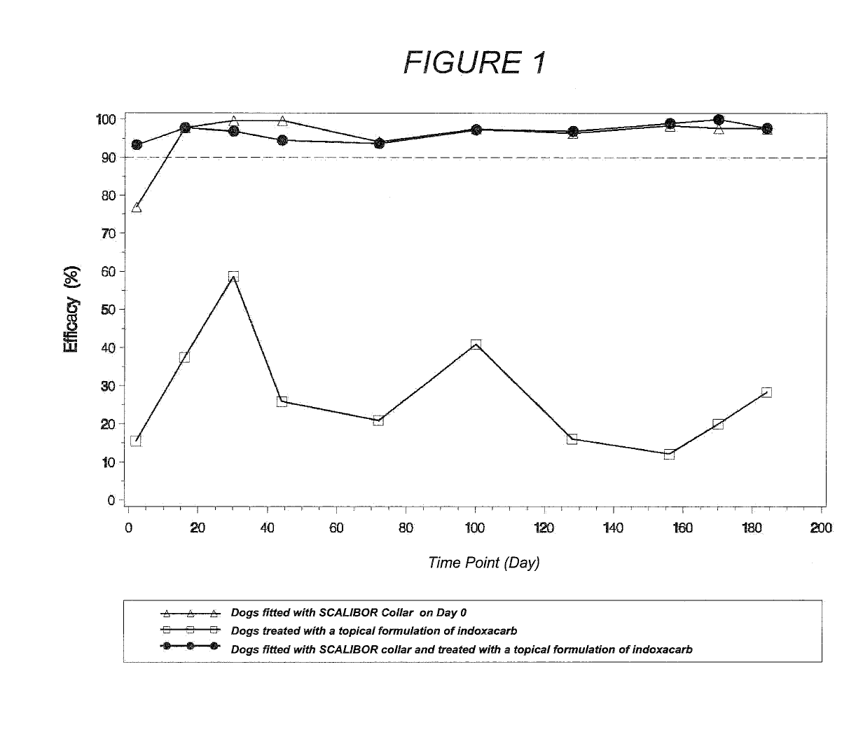

Efficacy values (%) based on arithmetic and geometric means for the groups treated with the investigational veterinary products against Rhipicephalus sanguineus ticks are summarized in Table 3 and FIG. 1:

Efficacies based on geometric means were considered primary. Immediate efficacies (Day+2)>90% were recorded for Group 4 only (93.3%). Greater than 90% persistent efficacies (Day+16 onwards) were recorded for Group 2 (Scalibor® collar) and Group 4 (Scalibor® collar and indoxacarb) up to Day 184. No immediate or persistent effectiveness against R. sanguineus ticks were however recorded for Group 3 (indoxacarb).

### Flea Counts

Arithmetic and geometric mean flea counts on the various assessment days for the five study groups are in Table 5. The arithmetic mean flea counts recorded for the negative control group ranged from 43.3 to 80.3 with the majority of arithmetic mean counts being >50 fleas.

Efficacy Data C. felis

Efficacy values (%) based on arithmetic and geometric means for the groups treated with the investigational veterinary products against (Ctenocephalides felis) fleas are summarized in Table 6:

Efficacies based on geometric means were considered primary. Immediate efficacies (Day+2)>95% were recorded for Group 3 (indoxacarb) and Group 4 (Scalibor® collar and indoxacarb). Persistent efficacies (Day+9 onwards)>95% were recorded for Group 3 (indoxacarb) and Group 4 (Scalibor® collar and indoxacarb) up to Day+177. Except on Day+65, <95% efficacies against C. felis fleas were recorded for Group 2 (Scalibor® collar) up to Day+177.

### CONCLUSION

The combination of indoxacarb and deltamethrin produced a faster kill of ticks than deltamethrin alone. The combination provided 93.3% and deltamethrin alone provided 76.9% killing of ticks by day 2 post.

The monthly indoxacarb spot-on treatments in combination with a once off Scalibor® collar treatment to dogs resulted in an immediate effectiveness against existing tick (R. sanguineus) and flea (C. felis) infestations of 93.3% and 96.4%, respectively.

The indoxacarb spot-on and Scalibor® collar combination treatment also resulted in a persistent effectiveness period of six months against ticks (R. sanguineus) and fleas (C. felis). The above mentioned treatments not administered in combination were however only effective against ticks (Scalibor® collar) or fleas (indoxacarb) and not both.

No adverse reactions related to treatments were observed.

TABLE 3
Tick counts

| | GROUP 1 - | | GROUP 2 - IVP | | | | GROUP 4 - IVP | |
|---|---|---|---|---|---|---|---|---|
| | Negative | | (Scalibor ® | | GROUP 3 - IVP | | (Scalibor ® collar | |
| | control | | collar) | | (indoxacarb) | | and indoxacarb) | |
| | Arithmetic | Geometric | Arithmetic | Geometric | Arithmetic | Geometric | Arithmetic | Geometric |
| DAY | mean | mean | mean | mean | mean | mean | mean | mean |
| +2 | 21.6 | 21.4 | 5.8 | 4.9¹ | 18.8 | 18.1⁴ | 2.6 | 1.4^{3,5,6} |
| +16 | 20.9 | 19.4 | 0.6 | 0.4¹ | 13.8 | 12.1⁴ | 0.6 | 0.4^{3,6} |
| +30 | 24.1 | 23.7 | 0.1 | 0.1¹ | 14.0 | 9.8^{2,4} | 1.3 | 0.7^{3,6} |
| +44 | 24.5 | 24.2 | 0.1 | 0.1¹ | 18.4 | 18.0⁴ | 1.8 | 1.3^{3,5} |
| +72 | 30.6 | 29.7 | 2.5 | 1.7¹ | 24.5 | 23.5⁴ | 2.5 | 1.9^{3,6} |
| +100 | 28.3 | 27.1 | 1.3 | 0.7¹ | 18.3 | 16.0⁴ | 1.1 | 0.7^{3,6} |
| +128 | 27.9 | 26.9 | 2.8 | 1.0¹ | 24.5 | 22.6⁴ | 1.4 | 0.8^{3,6} |
| +156 | 28.9 | 28.5 | 0.9 | 0.5¹ | 25.4 | 25.0⁴ | 0.4 | 0.3^{3,6} |
| +170 | 25.9 | 24.9 | 1.0 | 0.6¹ | 21.1 | 19.9⁴ | 0.0 | 0.0^{3,5,6} |
| +184 | 24.4 | 23.9 | 1.3 | 0.6¹ | 18.3 | 17.1⁴ | 0.8 | 0.5^{3,6} |

¹Group 2 differed statistically significantly (p < 0.05) from the negative control Group 1
²Group 3 differed statistically significantly (p < 0.05) from the negative control Group 1
³Group 4 differed statistically significantly (p < 0.05) from the negative control Group 1
⁴Group 3 differed statistically significantly (p < 0.05) from the Group 2
⁵Group 4 differed statistically significantly (p < 0.05) from the Group 2
⁶Group 4 differed statistically significantly (p < 0.05) from the Group 3

TABLE 4
Tick efficacy

| | TICK EFFICACIES (%) | | | | | |
|---|---|---|---|---|---|---|
| | GROUP 2 - IVP | | | | GROUP 4 - IVP | |
| | (Scalibor ® | | GROUP 3 - IVP | | (Scalibor ® collar | |
| | collar) | | (indoxacarb) | | and indoxacarb) | |
| | | Geo- | | Geo- | | Geo- |
| | Arithmetic | metric | Arithmetic | metric | Arithmetic | metric |
| DAY | mean | mean | mean | mean | mean | mean |
| +2 | 73.4 | 76.9 | 13.3 | 15.5 | 87.9 | 93.3 |
| +16 | 97.0 | 97.8 | 34.3 | 37.4 | 97.0 | 97.8 |
| +30 | 99.5 | 99.6 | 42.0 | 58.7 | 94.8 | 96.9 |
| +44 | 99.5 | 99.6 | 25.0 | 25.8 | 92.9 | 94.5 |
| +72 | 91.8 | 94.2 | 20.0 | 20.9 | 91.8 | 93.7 |
| +100 | 95.6 | 97.5 | 35.4 | 40.9 | 96.0 | 97.3 |
| +128 | 90.1 | 96.4 | 12.1 | 16.0 | 95.1 | 97.0 |
| +156 | 97.0 | 98.4 | 12.1 | 12.2 | 98.7 | 99.0 |
| +170 | 96.1 | 97.7 | 18.4 | 20.0 | 100.0 | 100.0 |
| +184 | 94.9 | 97.6 | 25.1 | 28.3 | 96.9 | 97.7 |

TABLE 5
Flea counts

| | GROUP 1 - | | GROUP 2 - IVP | | | | GROUP 4 - IVP | |
|---|---|---|---|---|---|---|---|---|
| | Negative | | (Scalibor ® | | GROUP 3 - IVP | | Scalibor ® collar | |
| | control | | collar) | | (indoxacarb) | | and indoxacarb) | |
| | Arithmetic | Geometric | Arithmetic | Geometric | Arithmetic | Geometric | Arithmetic | Geometric |
| DAY | mean | mean | mean | mean | mean | mean | mean | mean |
| +2 | 61.5 | 56.4 | 18.1 | 13.5¹ | 0.1 | 0.1^{2,4} | 7.4 | 2.0^{3,5,6} |
| +9 | 43.3 | 34.6 | 12.9 | 8.6¹ | 0.0 | 0.0^{2,4} | 0.1 | 0.1^{3,5} |
| +30 | 55.5 | 54.3 | 11.5 | 5.5¹ | 0.0 | 0.0^{2,4} | 1.5 | 0.6^{3,5} |
| +37 | 80.3 | 77.8 | 15.1 | 6.3¹ | 0.0 | 0.0^{2,4} | 0.1 | 0.1^{3,5} |
| +65 | 51.6 | 48.5 | 4.4 | 1.8¹ | 0.0 | 0.0^{2,4} | 0.0 | 0.0^{3,5} |
| +93 | 44.4 | 37.2 | 10.4 | 3.3¹ | 0.0 | 0.0^{2,4} | 0.0 | 0.0^{3,5} |
| +121 | 55.0 | 54.6 | 11.6 | 3.5¹ | 0.0 | 0.0^{2,4} | 0.0 | 0.0^{3,5} |
| +149 | 62.0 | 60.6 | 12.5 | 3.7¹ | 0.0 | 0.0^{2,4} | 0.0 | 0.0^{3,5} |
| +163 | 48.9 | 32.4 | 7.9 | 2.0¹ | 0.0 | 0.0^{2,4} | 0.0 | 0.0^{3,5} |
| +177 | 66.6 | 65.0 | 10.1 | 6.3¹ | 0.0 | 0.0^{2,4} | 0.0 | 0.0^{3,5} |

¹Group 2 differed statistically significantly (p < 0.05) from the negative control Group 1
²Group 3 differed statistically significantly (p < 0.05) from the negative control Group 1
³Group 4 differed statistically significantly (p < 0.05) from the negative control Group 1
⁴Group 3 differed statistically significantly (p < 0.05) from the Group 2
⁵Group 4 differed statistically significantly (p < 0.05) from the Group 2
⁶Group 4 differed statistically significantly (p < 0.05) from the Group 3

TABLE 6
Flea efficacy

| | FLEA EFFICACIES (%) | | | | | |
|---|---|---|---|---|---|---|
| | GROUP 2 - IVP | | | | GROUP 4 - IVP | |
| | (Scalibor ® | | GROUP 3 - IVP | | (Scalibor ® collar | |
| | collar) | | (indoxacarb) | | andindoxacarb) | |
| | | Geo- | | Geo- | | Geo- |
| | Arithmetic | metric | Arithmetic | metric | Arithmetic | metric |
| DAY | mean | mean | mean | mean | mean | mean |
| +2 | 70.5 | 76.1 | 99.8 | 99.8 | 88.0 | 96.4 |
| +9 | 70.2 | 75.2 | 100.0 | 100.0 | 99.7 | 99.7 |
| +30 | 79.3 | 89.8 | 100.0 | 100.0 | 97.3 | 98.9 |
| +37 | 81.2 | 91.9 | 100.0 | 100.0 | 99.8 | 99.9 |
| +65 | 91.5 | 96.3 | 100.0 | 100.0 | 100.0 | 100.0 |
| +93 | 76.6 | 91.2 | 100.0 | 100.0 | 100.0 | 100.0 |
| +121 | 78.9 | 93.7 | 100.0 | 100.0 | 100.0 | 100.0 |
| +149 | 79.8 | 93.9 | 100.0 | 100.0 | 100.0 | 100.0 |
| +163 | 83.9 | 94.0 | 100.0 | 100.0 | 100.0 | 100.0 |
| +177 | 84.8 | 90.3 | 100.0 | 100.0 | 100.0 | 100.0 |

### Example 2

### Electrophysiological Studies

The objective of the study was to explore the electrophysiological effects of combined exposure of DCJW (IN-JT333), the bioactivated metabolite of indoxacarb, and deltamethrin on insect neuronal preparations.

Both DCJW and deltamethrin are sodium channel blocker and/or modulator insecticides, but the manner they alter insect sodium channels differs. This study was performed to investigate the effects of this combination on insect neuronal preparation, in terms of pharmacological additivity, synergy or interaction.

In insects, the parent compound indoxacarb is rapidly bioactivated by a hydrolase, to produce the N-decarbomethoxyllated metabolite DCJW (IN-JT333), which is known to block sodium-dependent action potentials in lepidopteran (Manduca sexta) larval motor nerve preparations, and to induce a dose-dependent inhibition of voltage-dependent inward sodium current (Wing et al., (1998), Arch. Insect Biochem. Physiol., 37, 91-103; Lapied et. al., 2001; Zhao et al., (2005), NeuroToxicology 26, 455-465

DCJW is used in this study because the relevant hydrolase is not present in this in-vitro system.

### Materials and Methods

### Test Items

DCJW was provided by E. I. du Pont de Nemours and Company, Wilmington Del.
Deltamethrin was provided by Intervet Productions S.A., Rue de Lyons, 27460, Igoville, France.
Both products were stored at ambient temperature.

Experiments were performed on dorsal unpaired median (DUM) neuron cell bodies (Grolleau and Lapied (2000), J. Exp. Biol., 203, 1633-1648) isolated from the dorsal midline of the terminal abdominal ganglion of adult male cockroaches (Periplaneta Americana) taken from a stock colony, maintained at 29° C. with a photoperiod of 12 hours light:12 hours dark.

### Cell Isolation

Adult male cockroaches were immobilised dorsal-side up on a dissection dish. The dorsal cuticle, gut and some dorso-longitudinal muscles were removed, to allow access to the ventral nerve cord. The abdominal nerve cord and its terminal abdominal ganglion (TAG), carefully dissected under a binocular microscope, were placed in normal saline. Isolation of adult DUM neuron cell bodies was performed under sterile conditions using enzymatic digestion and mechanical dissociation of the median part of the TAG (Lapied et al. (1989), J. Exp. Biol., 144, 535-549).

Based on the cobalt-filling technique together with immuno-histochemical mapping and electrophysiological recordings, most of TAG DUM neurons investigated formed a relatively homogeneous population of cells (Lapied et al. 1989; Sinakevitch et al. (1996), J. Comp. Neurol., 367, 147-163).

Ganglia were excised and incubated for 35 min at 29° C. in cockroach saline supplemented with 1.5 mg/ml collagenase (type I, Worthington, Lakewood, N.J.). After thoroughly washing off the enzyme, ganglia were mechanically dissociated by gentle repeated suctions through fire-polished Pasteur pipettes. Then, the isolated DUM neuron cell bodies were maintained at 29° C. for 24 hours before experiments are carried out. Under these conditions, DUM neuron cell bodies did not display neurite outgrowth.

### Study Design

Isolated neuronal cell bodies were used for electrophysiological studies. For each test, a single cell body was treated by DCJW (10-7M) alone or in combination with deltamethrin (10-5 M). A total number of six different isolated cell bodies (six replicates) were used for each experiment.

Deltamethrin and DCJW (IN-JT333), stock solutions (100 mM and 10 mM, respectively) were prepared in dimethylsulphoxide (DMSO, Sigma Chemical, France). Final dilutions contained a maximum of 0.1% DMSO.

These concentrations of solvent were found to be without effect on the electrical activity of DUM neurons.

Deltamethrin and DCJW, prepared in cockroach saline, were applied separately by a gravity perfusion system onto isolated cell body maintained in short-term culture.

As previously reported (Lapied et al. 2001), the voltage-dependent sodium channels expressed in DUM neurons are sensitive to DCJW in a dose-dependent manner. According to these results, the first experiment was performed to study the time course of the effect of DCJW alone at a concentration of 10-7 M, which is very close to the concentration that produces 50% inhibition of the peak inward sodium current.

Deltamethrin was applied at 10-5 M, as the concentration that produces 50% inhibition of the peak inward sodium current. (Pelhate and Sattelle (1982), J. Insect Physiol., 28, 889-903.)

### Experimental Procedures

### Electrophysiological Recording

Experiments were carried out at room temperature (20° C.).

The patch-clamp technique in the whole-cell recording configuration (voltage-clamp condition) was used to record voltage-dependent inward sodium current.

Patch pipettes were pulled from borosilicate glass capillary tubes (GC 150 T-10; Harvard Apparatus, Edenbridge, UK) with a PP-83 electrode puller (Narishige, Tokyo, Japan). Pipettes have a resistance ranging from 0.9 to 1.1 M□ (voltage-clamp mode). The liquid junction potential between the pipette and the superfusing solution was always corrected before the formation of a gigaohm seal >2 GΩ.

Signals were recorded with an Axopatch 200A amplifier (Axon Instruments, Foster City, Calif., USA). Step voltage pulses were generated by a programmable stimulator (SMP 310; Biologic, Claix, France) or an IBM computer with software control pClamp 8.0.3 connected to a 125-kHz labmaster DMA data acquisition system (TL-1; Axon Instruments).

For voltage-clamp experiments, the protocols used to record sodium currents have already been described elsewhere (Lapied et al. (1990), J. Exp. Biol., 151, 387-403.). Series resistance value was obtained for each experiment from the patch-clamp amplifier settings after compensation and varied between 1.5 and 3 MW.

Cells were voltage-clamped at a holding potential of −90 mV and 30-ms depolarizing test pulses (except when otherwise stated) were applied from the holding potential at a frequency of 0.1 Hz (sampling frequency 30 kHz) to record inward sodium current. Electrophysiological signals were stored on the hard disk of the computer for subsequent off-line analysis.

### Results Evaluation and Statistical Analysis

It is possible to characterize all the ion channels involved in the different phases of the spontaneous electrical activity using the patch-clamp technique. Their corresponding physiological functions have been clearly identified (Grolleau and Lapied, 2000), which allows the determination of the mode of action of a specific insecticide on a given membrane target.

For each time point, relative sodium current amplitudes are expressed as means±standard errors of the mean (SEM) (table 2). To estimate the effect of insecticides tested, only current amplitudes at 20 minutes, corresponding to the steady-state recording conditions, are considered.

The inhibitory effect observed on the current amplitude was converted into a percentage of inhibition (100% corresponding to the control current amplitude).

Regarding statistical analysis, normal distribution (or Gaussian distribution) of the data was tested using Kolmogorov-Smirnov at a significance of p<0.05 (Chakravarti, Laha, and Roy (1967). Handbook of Methods of Applied Statistics) and R software (R version 2.9.0 Software). The hypothesis regarding the normal distribution had to be rejected if the test statistic, D was greater than the critical value Dα(n) obtained from a table (Dα₍ₙ₌₆₎=0.521; and n=8:Dα₍ₙ₌₈₎=0.457).

If the frequency distribution of data was Gaussian, the student-t test had to be used (parametric statistical method). If the hypothesis regarding normal distribution was rejected, the Mann-Whitney test had to be used (nonparametric statistical method).

In addition to the concomitant application of deltamethrin and DCJW, the effect of the mixture DCJW (10⁻⁷M) and deltamethrin (10⁻⁵ M) on DUM neuron was assessed after a pre-treatment of the cell body by deltamethrin (10⁻⁵ M) for 5 minutes.

### Results

Effects of DCJW Alone and Co-Applied with Deltamethrin on the Voltage-Dependent Sodium Current.

A time course experiment was performed to measure the reduction of the inward sodium current amplitude by DCJW (10⁻⁷ m) tested alone, in combination with deltamethrin 10⁻⁵ m.

The sodium current amplitude following external application of 10⁻⁷ M DCJW was 59.3% (SEM 8.2%) after 20 minutes of treatment.

The percentage of inhibition of the current amplitude was therefore 40.7%.

In order to study the possible interaction between DCJW and deltamethrin on the sodium current amplitude, a mixture of DCJW and deltamethrin, was tested:

The inhibitory effect of the mixture measured at 20 minutes was greater than the inhibition observed with DCJW applied alone. The inward sodium current amplitude of the combination was 20.0%±8.4%. The percentage of inhibition was therefore 80.0%.

All values passed the Kolmogorov-Smirnov normality test. The difference of current inhibitions between DCJW tested alone and the mixture were therefore compared by the Student unpaired t test (Table 4). The difference was statistically significant (p<0.05).

Effects of DCJW on the Voltage-Dependent Sodium Current after a Pre-Treatment with Deltamethrin.

After pre-treatment for 5 minutes with deltamethrin (10⁻⁵ M) the time course experiment was repeated. The mixture of DCJW (10⁻⁷M) and deltamethrin (10⁻⁵M) also resulted in significant reduction of the sodium current amplitude. The relative sodium current means and SEM under these conditions were 11.1%+5.7%.

The inhibitory effect was very similar to that of obtained without pre-treatment, i.e. 88.9%, versus 80.0 without pre-treatment

Pre-treatment values did not pass the Kolmogorov-Smirnov normality test. The current inhibitions between DCJW alone and DCJW with deltamethrin pre-treatment were therefore compared using the Mann-Whitney test. The difference was statistically significant (p<0.05).

### CONCLUSIONS

The results presented above demonstrate that reduction of the DUM neuron sodium current amplitude observed with DCJW is strongly potentiated when deltamethrin is co-applied with DCJW (synergistic effect).

Both DCJW and deltamethrin affect specifically electrophysiological properties of insect inward sodium current. However, the mode of action of these two insecticides is very different, since the sites affected within the target (i.e. the sodium channel) are not similar.

DCJW is the bioactivated metabolite of indoxacarb, a pyrazoline insecticide. Pyrazoline insecticides produce typical acute neurotoxic symptoms in insects, characterized by a pseudoparalysis. This neurotoxic effect is associated with a complete absence of spontaneous activity in the nervous system of insects poisoned by such insecticides. The complete absence of neural activity indicates that DCJW blocks voltage-dependent sodium channels, which are responsible for the initiation and propagation of action potentials.

Deltamethrin is a pyrethroid insecticide with a synthetic structural derivative of natural pyrethrins present in the pyrethrum extracts of Chrysanthemum. Deltamethrin is a pyrethroid type II molecule. These pyrethroids cause a membrane depolarization accompanied by a suppression of the action potential. Under voltage-clamp conditions, type II pyrethroids inhibit the deactivation of sodium channels.

Without being bound by theory, the potentiation observed in the presence of the mixture of DCJW and deltamethrin compared to DCJW applied alone suggests the involvement of an intracellular signalling pathway, regulating the biophysical properties of the sodium channels.

In addition, the synergistic interaction between deltamethrin and DCJW is directly observed when the insecticides are applied concomitantly. This effect is very similar to the effect obtained when the DUM neuron cell bodies are pre-treated with deltamethrin tested alone. This confirmed that it is not necessary to perform any pre-treatment to obtain the synergistic effect. By contrast, such a pre-treatment is required to obtain a synergy between pyrethroids and anti-cholinesterasic compounds.

### Example 3

### Further Electrophysiological Studies

The objective of the study was to further characterize the electrophysiological effects of combined exposure of the N-decarbomethoxyllated metabolite of indoxacarb, DCJW (IN-JT333), and deltamethrin, on cockroach (Periplaneta Americana) neuronal preparations.

Particularly, these experiments were directed toward determining the optimal ratio between deltamethrin and indoxacarb to produce the most effective inhibitory effect of DCJW on neuronal voltage-dependent sodium channels, using the patch-clamp technique.

The second part of the study was to explore the potential interaction between deltamethrin and metaflumizone, a semi-carbazone insecticide expected to have a mode of action very similar to that of DCJW. These results were compared to those obtained with the mixture deltamethrin-DCJW.

DCJW (10-7 M) was tested in this model, in combination with increasing concentrations of deltamethrin (10-7M, 3.10-7M, 6.10-7 M, 10-6 M, 3.10-6 M and 10-5 M).

In a second step, deltamethrin (3.10.6 M) was tested in combination with increasing concentrations of DCJW (10-10 M, 10-9M, 3.10-9 M, 10-8 M). Finally, increasing concentrations of Metaflumizone (10-10 M, 10-9 M, 10-8 M, 10-7 M, 10-8 M and 10-5M) were tested, alone or in combination with deltamethrin.

### Materials and Methods

### Test Items

DCJW and Deltamethrin were sourced as described in Example 2. Metaflumizone:(EZ)-2012-(4-cyanophenyl)-1-(a,a,a-trifluoro-m tolypethylidene]-4 (trifluoromethoxy) carbanilohydrazide, was reagent grade.

### Cell Isolation

Cell isolation was as described in Example 2.

### Study Design

Each electrophysiological test was performed on six to nine different isolated neuronal cell bodies (replicates).

For each test, cell bodies were exposed to insecticides alone or to the combination of the two compounds concomitantly, as described in the Table 7 below.

TABLE 7
Study design

| | REPLI- |
|---|---|
| TREATMENTS | CATES |
| DCJW at 10⁻ M and deltamethrin at 10 [symbol] M, concomitantly | 6 |
| DCJW at 10⁻⁷ M and deltamethrin at 3 · 10⁻⁷ M, concomitantly | 8 |
| DCJW at 10⁻⁷ M and deltamethrin at 6 · 10⁻⁷ M, concomitantly | 8 |
| DCJW at 10⁻⁷ M and deltamethrin at 10⁻⁶ M, concomitantly | 7 |
| DCJW at 10⁻⁷ M and deltamethrin at 3 · 10⁻⁶ M, concomitantly | 9 |
| DCJW at 10 [symbol] M and deltamethrin at le M, concomitantly | 6 |
| Deltamethrin at 3 · 10⁻⁶ M and DCJW at 10⁻¹⁰ M, | 6 |
| concomitantly | |
| Deltamethrin at 3 · 10⁻⁶ M and DCJW at 10⁻⁹ M, concomitantly | 6 |
| Deltamethrin at 3 · 10⁻⁶ M and DCJW at 3 · 10⁻⁹ M, | 6 |
| concomitantly | |
| Deltamethrin at 3 · 10⁻⁶ M and DCJW at 10⁻⁸ M, concomitantly | 6 |
| Metaflumizone at 10⁻¹⁰ M | 7 |
| Metaflumizone at 10⁻⁹ M | 8 |
| Metaflumizone at 10⁻⁸ M | 8 |
| Metaflumizone at 10⁻⁷ M | 6 |
| Metaflumizone at 10⁻⁶ M | 7 |
| Metaflumizone at 10⁻⁵ M | 7 |
| Metaflumizone at 10⁻⁸ M and deltamethrin at 3 · 10⁻⁶ M, | 6 |
| Metaflumizone at 10⁻⁷ M and deltamethrin at 3 · 10⁻⁶ M, | 6 |

[symbol]

indicates data missing or illegible when filed

Deltamethrin, metaflumizone E/Z and DCJW, stock solutions (100 mM and 10 mM) were dissolved in dimethylsulphoxide (DMSO, Sigma Chemical, France) and diluted as described in Example 2, as was metaflumizone E/Z.

### Experimental Procedures

### Electrophysiological Recording

Electrophysiologic recording was as described in Example 2.

### Results Evaluation and Statistical Analysis

As noted in Example 2, the patch-clamp technique allows the characterization of all ion channels involved in the different phases of the spontaneous electrical activity. Their corresponding physiological functions are clearly identified, which facilitates the study of the mode of action of a specific insecticide on a given membrane target.

As previously reported (Lapied et. al. (2001), Brit. J. Pharmacol., 132, 587-595; Lavialle-Defaix et al., 2010), the voltage-dependent sodium channels expressed in DUM neurons are sensitive to DCJW in a dose-dependent manner. Based to these results, the first experiment was performed to study the time course of the effect of DCJW alone at the concentration of 10-7 M, which is very close to the concentration that produces 50% inhibition of the peak inward sodium current.

As in Example 2, for each time point, relative sodium current amplitudes were expressed as means±standard errors of the mean (SEM). To estimate the effect of insecticides tested, only current amplitudes at 20 minutes corresponding to the steady-state recording conditions, are considered.

The inhibitory effect observed on the sodium current amplitude was then converted into a percentage of inhibition (100% corresponding to the control current amplitude).

Regarding statistical analysis, normal distribution (or Gaussian distribution) of the data was tested using Kolmogorov-Smirnov at a significance of p<0.05 (Chakravart et al., 1967) and R software (R version 2.9.0 Software). The hypothesis regarding the normal distribution had to be rejected if the test statistic, D was greater than the critical value Dα(n) obtained from a table (for example: Dα₍ₙ₌₆₎=0.521).

For Gaussian distribution of data is, the one way ANOVA had to be used (parametric statistical method). If the hypothesis regarding normal distribution was rejected, the Mann-Whitney test had to be used (nonparametric statistical method).

### Results

### Determination of the Minimum Concentration of Deltamethrin Necessary to Obtain the Maximum Potentiation of DCJW Effect.

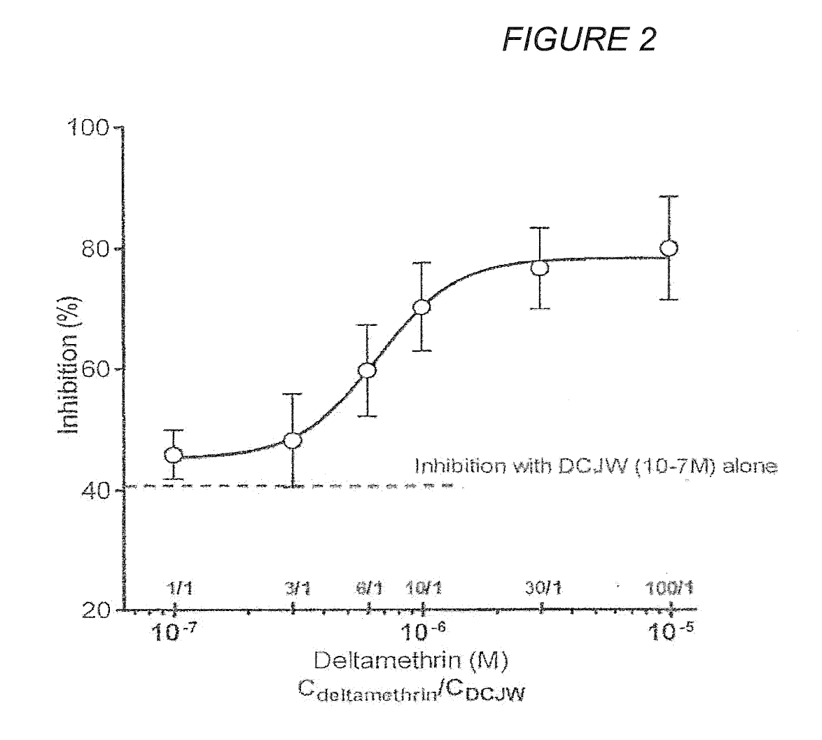

The percentage of residual sodium current amplitudes measured from the control current (100%) following concomitant application of 10⁻⁷ M DCJW with 10⁻⁷ M, 3.10⁻⁷ M, 6.10⁻⁷ M, 10⁻⁶ M, 3.10⁻⁶ M and 10⁻⁵ M deltamethrin were respectively 54.2±4.0, 51.9±7.6, 40.3±7.6, 29.8±7.4, 23.3±6.7 and 20.0±8.4% after 20 minutes of treatment. A semi-logarithmic dose response curve is shown in FIG. 2. (The corresponding real percentages of inhibition of the current amplitudes were therefore 45.8, 48.2, 59.7, 70.3, 76.7 and 80.0%. All values passed the Kolmogorov-Smirnov normality test.

### Determination of the Minimum Concentration of DCJW Necessary to Obtain the Maximum Potentiation of Deltamethrin Effect

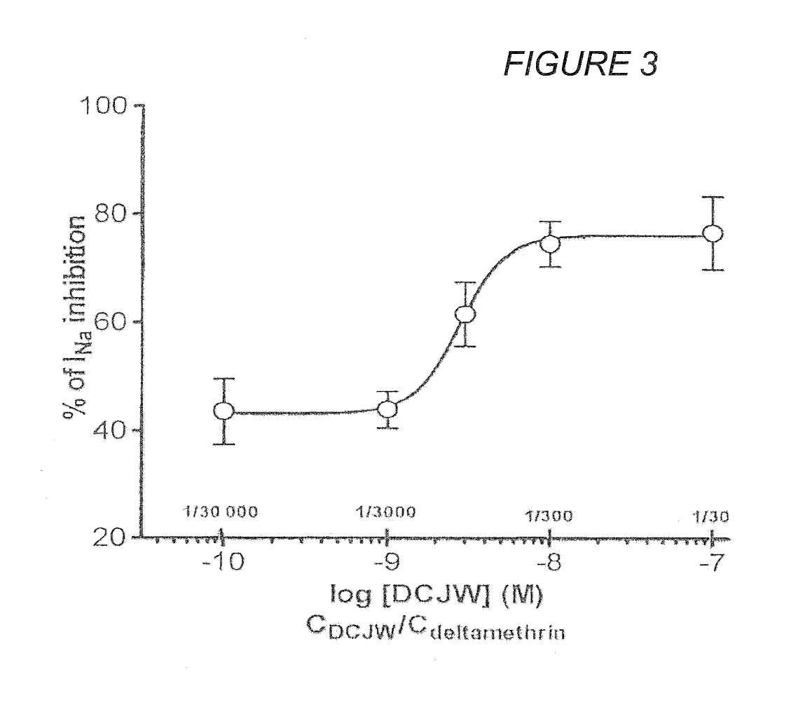

The percentage of residual sodium current amplitudes measured from the control (100%) following concomitant application of 3.10⁻⁶ M deltamethrin and 10⁻¹⁰, 10⁻⁹, 3.10⁻⁹, 10⁻⁸ and 10⁻⁷ DCJW were respectively 56.4±6.1, 56.3±3.4, 38.4±5.9, 25.4±4.7 and 23.3±6.7% after 20 minutes of treatment. A semi-logarithmic dose response curve is shown in FIG. 3.

The corresponding real percentages of inhibition of the current amplitudes were therefore 43.6, 43.9, 61.6, 74.6 and 76.7%. All values passed the Kolmogorov-Smirnov normality test.

Comparison of the Percentage of Inhibition of the Sodium Current Amplitude Recorded after 20 Minutes of Treatment with DCJW Alone, Deltamethrin Alone and the Most Effective Ratio of DCJW/Deltamethrin Mixture

The most effective ratio of DCJW/deltamethrin was determined to be DCJW 10⁻⁸ M/deltamethrin 3.10⁻⁶ M.

The difference of the current inhibition between DCJW (10⁻⁷ M) tested alone, deltamethrin (10⁻⁵ M) and the mixture (deltamethrin 3.10⁻⁶ M, DCJW 10⁻⁸ M) were compared by ANOVA. This mixture, containing 10 times less DCJW and 3 times less deltamethrin, was significantly more effective than either drug alone. Thus confirming the synergistic results observed in Example 2.

### Characterization of the Possible Interaction Between Deltamethrin and Metaflumizone E/Z

Bath application of metaflumizone E/Z at different concentrations were applied onto isolated DUM neurons, produced a reduction of the sodium current amplitude. The effect was not dose-dependent since the reduction in current amplitude observed at different concentrations was not statistically significant.

We then tested the effect of metaflurnizone E/Z (10⁻⁸ M and 10⁻⁷ M) combined to the most effective concentration of deltamethrin (3.10⁻⁶M). No statistically significant difference was observed at any concentration tested.

### CONCLUSION

Taken together, these results indicated that there was significant synergistic effect when deltamethrin was combined with DCJW on the sodium current amplitude.

The minimum deltamethrin concentration needed to strongly increase the effect of DCJW (used at 10⁻⁷ M) was determined to be 3.10⁻⁶ M. In other words, when the minimum deltamethrin concentration was used (i.e., 3.10⁻⁶ M), the maximum effect of DCJW was obtained for a concentration more than 10-fold lower than in the absence of deltamethrin. Not intending to be bound by theory, the semi-logarithmic dose-response curve observed suggests a positive allosteric effect of deltamethrin on the sodium channels, which thereby increase the DCJW efficacy.

Parallel experiments were designed to study the effect of metaflumizone E/Z alone and combined with deltamethrin. We did not observe any statistically significant effect which is surprising considering the similar mode of action of metaflumizone and DCJW.

What is claimed is:

1. A parasiticidal combination comprising as active compounds indoxacarb and deltamethrin in synergistically effective amounts.

2. The parasiticidal combination according to claim 1 wherein the ratio of indoxacarb to deltamethrin is between 1 to 10 and 10 to 1.

3. The parasiticidal composition comprising the combination according to claim 1 and a pharmaceutically acceptable carrier.

4. A method for combating parasitic insects and acarids on an animal which comprises administering to the animal an effective amount of the combination according to claim 1 to the animal in need thereof.

5. The method according to claim 4 wherein the animal is infested with parasitic insects and acarids.

6. The method according to claim 4 wherein infestation of the animal is prevented.

7. The method according to claim 4 wherein indoxacarb and deltamethrin are administered together simultaneously in a common formulation, or in separate formulations, in parallel.

8. The method according to claim 7 wherein the indoxacarb and deltamethrin are administered in a common formulation.

9. The method according to claim 4 wherein the animal is a dog.

10. The method according to claim 8 wherein the common formulation is a collar.

11. The method according to claim 4 wherein the indoxacarb and deltamethrin are contained in two separate formulations wherein the formulation containing deltamethrin is in the form of a collar impregnated with deltamethrin.

12. A kit useful for combating insects and/or acarids in an animal, which comprises indoxacarb and deltamethrin in a single composition or separate compositions packaged together and instructions for the control of parasitic insect- and acarid-infestations on animals.

13-20. (canceled)

21. The combination of claim 1, wherein the indoxacarb and deltamethrin are combined in a common formulation.

22. The combination of claim 21, wherein the common formulation is a collar.

23. The combination of claim 22, wherein the ratio of indoxacarb to deltamethrin is between 1 to 10 and 10 to 1.

24. The parasiticidal composition comprising the combination according to claim 2 and a pharmaceutically acceptable carrier.

25. The method according to claim 10, wherein the animal is a dog.

26. The method according to claim 11, wherein the animal is a dog.
